(19) United States
(12) Patent Application Publication
(10) Pub. No.: US 2022/0145073 A1
(43) Pub. Date: May 12, 2022

(54) METHOD FOR PRODUCING A POLYCARBONATE MOULDING COMPOUND

(71) Applicant: Covestro Intellectual Property GmbH & Co. KG, Leverkusen (DE)

(72) Inventors: Andreas Seidel, Dormagen (DE); Tobias Bubmann, Bayreuth (DE)

(21) Appl. No.: 17/602,809

(22) PCT Filed: Apr. 8, 2020
(86) PCT No.: PCT/EP2020/060046

§ 371 Date: Oct. 11, 2021

(30) Foreign Application Priority Data
Apr. 18, 2019 (EP) 19170040.0

(51) Int. Cl. C08L 69/00; C08L 33/12

(52) U.S. Cl. CPC C08L 69/00; C08L 33/12

(57) ABSTRACT

The present invention relates to a method for producing a thermoplastic moulding compound containing A) at least one aromatic polycarbonate and B) an additional polymer that is chemically different from polymer A and that contains at least one type of functional group selected from ester groups, epoxy groups, hydroxyl groups, carboxyl groups and carboxylic anhydride groups, comprising the steps of a) melting and thoroughly mixing the components A and B in the presence of a catalyst according to component Cat a temperature in the range of from 200° C. to 350° C. and b) solidifying the composition by cooling the composition, the component A having an average molecular weight M_{w} of at least 3000 g/mol, characterised in that, in the method step a), at least one part of the component A is reacted with the component B to form a copolymer, and the catalyst C being a specific phosphonium salt. The invention also relates to a thermoplastic moulding compound produced by the method according to the invention, and to moulded bodies containing said moulding compound.

The present invention relates to a process for producing polycarbonate molding material, to the molding material produced in such a process itself and to molded articles containing such a molding material.

Polycarbonate molding materials have been known for many years. The molding materials are used to produce molded articles for a multiplicity of applications, for example for the automotive sector, for the construction sector and for the electronics sector.

Polycarbonate blends may be produced by blending polycarbonate with further polymeric components and additives. The properties of such polycarbonate molding materials and the molded articles produced therefrom may be varied over wide ranges and adapted to the requirements of the respective application through suitable choice of their composition and production conditions.

However, polycarbonate is not or not completely miscible with many polymer blend partners such as vinyl polymers, polyolefins or polyesters, not even through extrusion in the melt. Because of this often present partial compatibility or incompatibility, separate phases form in the polycarbonate blends. Depending on the proportions of the respective polymeric components polycarbonate then for example forms a matrix phase, in which for instance the vinyl copolymer is then present in the form of more or less finely divided microscopically visible polymeric phases.

The polymeric blend partners that are incompatible or partially compatible with polycarbonate usually have a refractive index distinct from that of polycarbonate. The presence of multiphase compositions therefore leads to a nontransparent or even completely opaque appearance of the molded articles produced from the compositions. This is the case even when the individual blend partners such as for instance polycarbonate and polymethyl methacrylate (PMMA) themselves have a high optical transparency.

Furthermore, the phase interfaces in such multiphase compositions are also weak points with regard to mechanical properties. Cracks in the material can spread along these interfaces and lead to failure in the event of external stresses or to material delamination.

One option for increasing the compatibility of polycarbonate with polymeric blend partners and thus improving the optical and/or mechanical properties is the use of copolymers containing units of both polycarbonate and the polymeric blend partner. Such copolymers are preferably block or graft polymers. The copolymers then accumulate along the phase interfaces and lead to increased compatibility between the polycarbonate and the polymeric blend partner. This can then manifest in the desired improvements in properties.

For production of the recited copolymers, one previously described approach is the in situ reaction between polycarbonate and the polymeric blend partner during compounding in the melt in the presence of a catalyst (so-called reactive compounding or reactive compatibilization). Some documents disclose such a process for blends made of polycarbonate and PMMA.

WO 2016/138246 A1 discloses transparent polycarbonate/PMMA blends containing 9.9% to 40% by weight of polycarbonate and 59.9% to 90% by weight of PMMA which are produced in a melt compounding using 0.0025 to 0.1% by weight of a tin catalyst.

WO 2016/189494 A1 discloses transparent polycarbonate/PMMA blends containing 80% to 95% by weight of a specifically specified branched polycarbonate having an end cap content of 45% to 80% and 4.9% to 20% by weight of PMMA which are produced in a melt compounding by transesterification using 0.1% to 1.5% by weight of a catalyst, preferably selected from Zn, Sn and Ag compounds.

A. K. Singh, et al. “Reactive Compatibilization of Polycarbonate and Poly(methyl)methacrylate in the Presence of a Novel Transesterification Catalyst SnCl₂.2H₂O”, J. Phys. Chem. B 2011, 115, 1601-1607 discloses transparent polycarbonate/PMMA molding materials produced in a reactive compounding process using SnCl₂.2H₂O as catalyst.

A. K. Singh, et al. “Evidence for in situ graft copolymer formation and compatibilization of PC and PMMA during reactive extrusion processing in the presence of the novel organometallic transesterification catalyst tin(II) 2-ethylhexanoate”, RSC Advances, 2012, 2, 10316-10323 discloses translucent PC/PMMA molding materials produced in a reactive compounding process using tin(II) 2-ethylhexanoate as catalyst.

M. Penco, et al. “PMMA/PC Blends: Effect of Mixing Conditions on Compatibility”, Macromol. Symp. 2007, 247, 252-259 discloses homogeneous blends of PC and PMMA, produced using 1% by weight of tetrabutylammonium tetraphenylborate as transesterification catalyst in a discontinuous kneader in the melt with residence times of 2 minutes.

The selection of a suitable catalyst usually plays an essential role in the described reactive compounding. In view of the usually short residence times of often less than a minute, this applies in particular if the aim is to carry out the reactive compounding in a continuous twin-screw extruder. The catalyst should be sufficiently reactive that it can be added in the smallest possible amounts. If the catalyst remains in the polycarbonate blend, excessively high proportions of catalyst can lead to undesirable effects on properties such as for instance the color impression (yellowing).

A conversion of polycarbonate and polymeric blend partner to form a copolymer sufficient for compatibilization may in some polycarbonate blends be phenomenologically assessed visually on the basis of the transparency or turbidity of the blends produced. This is the case for example for polycarbonate/PMMA compositions in which, as mentioned previously, both polymers have a high transparency but the blend of polycarbonate and PMMA also becomes sufficiently transparent only through an improvement in phase compatibility (also referred to as polymer compatibility in the context of the present invention).

Phase compatibility can also be evaluated based on microscopic images, for example using TEM. In cases in which the domains of the blend partners are microscopically distinguishable, the domain size of the disperse phase provides an indication of compatibility. These domains become smaller if phase compatibility is improved through suitable measures.

The chemical reaction of polycarbonate with blend partners to form a block or graft copolymer may also be effected analytically during compounding via the decrease in the content of functional groups in the blend partner, for example via suitable spectroscopic methods (for example FTIR or NMR) or a titrimetric determination. The detection of such a reaction with the formation of a block or graft copolymer is often also possible via selective solution tests which are preferably coupled with a spectroscopic characterization of the proportions which are soluble and/or insoluble in various solvents. What is utilized here is the fact that the polycarbonate, the polymeric blend partner and the block or graft copolymer formed by the reaction thereof generally have different polarities and thus solubilities, thus enabling separation of these polymers.

Having regard to a suitable process for reaction of polycarbonate with a polymeric blend partner and selection of the catalyst there remained a need for further improvement even in light of the described disclosures.

It was therefore desirable to provide a process for producing thermoplastic molding materials in which polycarbonate is mixed with a polymeric blend partner and optionally further components, and a blend improved in terms of the polymer compatibility of the polycarbonate and the polymeric blend partner is obtained, wherein the improved polymer compatibility is achieved through better phase commixing, i.e. a more finely divided phase dispersion or a polymer miscibility in a wider mixing range. Such blends having improved polymer compatibility of the polycarbonate and the polymeric blend partner should exhibit for example improved optical properties (for example transparency and inherent color) and/or improved mechanical properties (for example increased stiffness, hardness, toughness and chemical/stress cracking resistance).

It has surprisingly been found that the object of the invention is achieved by the process for producing a thermoplastic molding material containing
A) at least one aromatic polycarbonate and
B) a further polymer which is chemically distinct from polymer A and which contains at least one type of functional group selected from ester, epoxy, hydroxyl, carboxyl and carboxylic anhydride groups,
   comprising the steps of
   a) melting and commixing the components A and B in the presence of a catalyst of component C at a temperature in the range from 200° C. to 350° C. and
   b) solidifying the composition by cooling the composition,

wherein the component A has an average molecular weight M_{w} measured by gel permeation chromatography at room temperature in methylene chloride with a bisphenol A-based polycarbonate standard of at least 3000 g/mol,

characterized in that

in process step a) at least a portion of the component A is reacted with the component B to afford a copolymer

and wherein the catalyst C is a phosphonium salt according to formula (4)

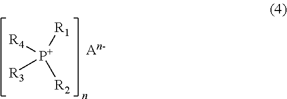

wherein

R₁ and R₂ each independently of one another represent C₁-C₁₀ alkyl, R₃ and R₄ each independently of one another represent C₁-C₁₀-alkyl or C₆-C₁₂-aryl,

Aⁿ⁻ represents the anion of a carboxylic acid and

n represents 1, 2 or 3.

Components A and B are preferably solids at room temperature.

Optionally also employable as component D in step a) are one or more polymer additives and/or further polymeric blend partners distinct from the components A and B.

The process may be performed in conventional apparatuses such as for example internal kneaders, twin-screw extruders, planetary roller extruders and continuous kneaders. Performance using a twin-screw extruder is preferred.

The commixing of the individual constituents of the compositions may be carried out in known fashion either successively or simultaneously. This means that for example some of the constituents may be introduced via the main intake of an extruder and the remaining constituents may be introduced later in the compounding process via a side extruder.

However, it is essential that the components A and B are finally in the presence of component C in liquid form or—if they are polymeric solids at room temperature—in melted form at a temperature in the range from 200° C. to 350° C.

The process is therefore carried out at a minimum temperature which—if components A and/or B are polymeric solids—is above the plasticizing temperatures of these components. If components A and/or B are crystalline polymeric solids the process is preferably carried out above the melt temperatures. The plasticizing temperatures and melt temperatures depend on the specific chemical structure of components A and B.

The process is preferably carried out at a temperature below the respective decomposition temperatures of the starting components A to D.

The process is preferably carried out in a temperature range from 220° C. to 300° C., particularly preferably from 230° C. to 270° C.

The residence time of the components at this temperature is preferably in a range from 10 seconds to 2 minutes, more preferably 15 seconds to 1 minute.

Commixing is also to be understood as meaning dispersing the components in one another if the components are not fully miscible in one another or if constituents that are in the form of a solid even at a temperature of 200° C. to 350° C. are present as component D. Such components may be fillers and reinforcers for example.

A degassing of the composition present may also be carried out after step a) by application of negative pressure. The absolute pressure established is preferably a pressure of not more than 400 mbar, more preferably not more than 200 mbar, particularly preferably not more than 100 mbar.

It is also possible for the catalyst to be deactivated or removed in step a) or after step a). This can have the advantage that undesired further reaction between components A and B during subsequent processing into molded articles is inhibited.

A granulation may also be carried out after or immediately before step b).

The copolymer from the reaction of the polymers A and B is generally a block copolymer or graft copolymer.

It is also preferable when a ring-opening addition reaction or a transesterification reaction takes place during reaction of the polymers A and B. In these cases it is not necessary for realization of high conversion rates to apply a vacuum to remove volatile reaction products.

When polymer B is an epoxy-containing vinyl (co)polymer or an epoxy-containing polyolefin, preferably at least 5 mol %, more preferably at least 10 mol %, particularly preferably at least 15 mol %, of the epoxy groups in the polymer B are converted in process step a).

It is further preferable when the mixture of the components A and B employed in step a) has a residual moisture content of 0.01% to 0.50% by weight, more preferably 0.07% to 0.20% by weight, in each case based on the sum of A and B. A residual moisture content in this range results in a higher reaction conversion and thus a higher yield of copolymer from the polymers A and B. At excessively high moisture content there is a risk of undesirably high molecular weight degradation.

It is preferable when step a) of the process according to the invention employs 0.5% to 99% by weight, more preferably 10% to 89.5% by weight, particularly preferably 30% to 84.5% by weight, of component A, 0.5% to 99% by weight, more preferably 10% to 89.5% by weight, particularly preferably 15% to 69.5% by weight, of component B, 0.01% to 0.5% by weight, more preferably 0.02% to 0.25% by weight, particularly 0.03% to 0.1% by weight, of component C.

When component D is employed in the process according to the invention this component is preferably used in a proportion of 0.1% to 50% by weight, more preferably of 0.3% to 30% by weight, particularly preferably of 0.4% to 20% by weight.

Component A

An aromatic polycarbonate is employed as Component A. It is also possible to employ mixtures of two or more aromatic polycarbonates.

Aromatic polycarbonates of component A which are suitable according to the invention are known from the literature or may be produced by processes known from the literature (for production of aromatic polycarbonates see, for example, Schnell, “Chemistry and Physics of Polycarbonates”, Interscience Publishers, 1964, and DE-AS 1 495 626, DE-A 2 232 877, DE-A 2 703 376, DE-A 2 714 544, DE-A 3 000 610, DE-A 3 832 396).

Aromatic polycarbonates are produced for example by reaction of diphenols with carbonyl halides, preferably phosgene and/or with aromatic dicarbonyl dihalides, preferably dihalides of benzenedicarboxylic acid, by the interfacial process, optionally using chain terminators, for example monophenols, and optionally using trifunctional or more than trifunctional branching agents, for example triphenols or tetraphenols. Production via a melt polymerization process by reaction of diphenols with for example diphenyl carbonate is likewise possible.

Diphenols for production of the aromatic polycarbonates and/or aromatic polyestercarbonates are preferably those of formula (1)

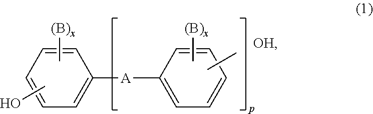

wherein

A is a single bond, C₁ to C₅-alkylene, C₂ to C₅-alkylidene, C₅ to C₆-cycloalkylidene, —O—, —SO—, —CO—, —S—, —SO₂—, C₆ to C₁₂-arylene, onto which further aromatic rings optionally containing heteroatoms may be fused, or a radical of formula (2) or (3)

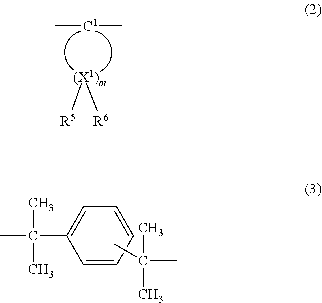

B is in each case C₁ to C₁₂-alkyl, preferably methyl, halogen, preferably chlorine and/or bromine,

x is independently at each occurrence 0, 1 or 2,

p is 1 or 0, and

R⁵ and R⁶ are individually choosable for each X¹ and are independently of one another hydrogen or C₁ to C₆-alkyl, preferably hydrogen, methyl or ethyl,

X1 is carbon and

m is an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis(hydroxyphenyl)-C₁-C₅-alkanes, bis(hydroxyphenyl)-C₅-C₆-cycloalkanes, bis(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropylbenzenes and also ring-brominated and/or ring-chlorinated derivatives thereof.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxybiphenyl sulfide, 4,4′-dihydroxybiphenyl sulfone, and also the di- and tetrabrominated or chlorinated derivatives of these, for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. 2,2-bis(4-hydroxyphenyl)propane (bisphenol A) is especially preferred. The diphenols may be used individually or in the form of any desired mixtures. The diphenols are known from the literature or obtainable by processes known from the literature.

Examples of chain terminators suitable for the production of the aromatic polycarbonates include phenol, p-chlorophenol, p-tert-butylphenol or 2,4,6-tribromophenol, and also long-chain alkylphenols such as 4-[2-(2,4,4-trimethylpentyl)]lphenol, 4-(1,3-tetramethylbutyl)phenol according to DE-A 2 842 005 and monoalkylphenol or dialkylphenols having a total of from 8 to 20 carbon atoms in the alkyl substituents, such as 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The amount of chain terminators to be used is generally between 0.5 mol % and 10 mol % based on the molar sum of the diphenols used in each case.

The aromatic polycarbonates have average molecular weights (weight-average M_{w}, measured by GPC (gel permeation chromatography) at room temperature in methylene chloride with a bisphenol A-based polycarbonate standard) of at least 3000 g/mol, preferably not more than 50 000 g/mol, more preferably from 5000 to 40 000 g/mol, particularly preferably from 10 000 to 35 000 g/mol, most preferably from 20 000 to 33 000 g/mol.

Suitable polycarbonates having M_{w} in the most preferred range are for example Makrolon™ M2408 and Makrolon™ M2606 (Covestro Deutschland AG, Leverkusen).

The preferred ranges result in a particularly advantageous balance of mechanical and rheological properties in the compositions according to the invention.

The aromatic polycarbonates may be branched in a known manner, and preferably through incorporation of 0.05 to 2.0 mol %, based on the sum of the diphenols used, of trifunctional or more than trifunctional compounds, for example those having three or more phenolic groups.

It is preferable to employ linear aromatic polycarbonates, more preferably based on bisphenol A.

Component B

A polymer chemically distinct from component A containing at least one type of functional group selected from ester, hydroxyl, carboxyl, carboxylic anhydride and epoxy groups is employed as Component B.

In polymers of component B the ester group may be either a constituent of the polymer chain (polymer backbone), as is the case in a polyester, or a functional group of a monomer that is not directly involved in the growth of the polymer chain, as is the case for an acrylate polymer.

It is also possible to use mixtures of different such polymers. The mixtures may in each case comprise polymers having identical functional groups or polymers having different functional groups.

The polymer B preferably contains at least one type of functional group selected from ester, carboxyl, epoxy and aromatic hydroxyl groups.

The polymer B particularly preferably contains at least one type of functional group selected from ester and epoxy groups.

In the context of the present invention polymers containing carbonate groups, i.e. esters of carbonic acid, are likewise regarded as polymers of component B provided they contain no aromatic structural units.

The component B is preferably a polymer selected from vinyl (co)polymers containing functional groups, polyolefins containing functional groups and polyesters.

The vinyl (co)polymers containing functional groups according to the invention are (co)polymers of at least one monomer from the group of (C₁ to C₈)-alkyl (meth)acrylates (for example methyl methacrylate, n-butyl acrylate, tert-butyl acrylate), unsaturated carboxylic acids and carboxylic anhydrides and other vinyl monomers containing ester, hydroxyl, carboxyl, carboxylic anhydride and epoxy groups.

The recited monomers may also be copolymerized with vinylaromatics (for example styrene, α-methylstyrene), vinyl cyanides (unsaturated nitriles such as acrylonitrile and methacrylonitrile) and olefins (such as ethylene).

Epoxy groups are introduced for example when the further monomer glycidyl methacrylate is copolymerized together with the other monomers.

These (co)polymers are resin-like and rubber-free. (Co)polymers of this kind are known and can be produced by free-radical polymerization, especially by emulsion, suspension, solution or bulk polymerization.

A particularly suitable vinyl polymer of component B is polymethyl methacrylate.

Particularly suitable vinyl polymers of component B further include styrene-acrylonitrile-glycidyl methacrylate terpolymers.

Suitable polyesters may be aliphatic or aromatic polyesters.

In a preferred embodiment the polyesters are aromatic, more preferably are polyalkylene terephthalates.

In a particularly preferred embodiment they are in this case reaction products of aromatic dicarboxylic acids or reactive derivatives thereof, such as dimethyl esters or anhydrides, and aliphatic, cycloaliphatic or araliphatic diols and also mixtures of these reaction products.

Particularly preferred aromatic polyalkylene terephthalates contain at least 80% by weight, preferably at least 90% by weight, based on the dicarboxylic acid component, of terephthalic acid radicals and at least 80% by weight, preferably at least 90% by weight, based on the diol component, of ethylene glycol and/or butane-1,4-diol radicals.

In addition to terephthalic acid radicals, the preferred aromatic polyalkylene terephthalates may contain up to 20 mol %, preferably up to 10 mol %, of radicals of other aromatic or cycloaliphatic dicarboxylic acids having 8 to 14 carbon atoms or of aliphatic dicarboxylic acids having 4 to 12 carbon atoms, for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred aromatic polyalkylene terephthalates may contain in addition to ethylene glycol and/or butane-1,4-diol radicals up to 20 mol %, preferably up to 10 mol %, of other aliphatic diols having 3 to 12 carbon atoms or cycloaliphatic diols having 6 to 21 carbon atoms, for example radicals of propane-1,3-diol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di((3-hydroxyethoxy)benzene, 2,2-bis(4-hydroxycyclohexyl)propane, 2,4-dihydroxy-1,1,3,3-tetramethylcyclobutane, 2,2-bis(4-(3-hydroxyethoxyphenyl)propane and 2,2-bis(4-hydroxypropoxyphenyl)propane (DE-A 2 407 674, 2 407 776, 2 715 932).

The aromatic polyalkylene terephthalates may be branched through incorporation of relatively small amounts of tri- or tetrahydric alcohols or tri- or tetrabasic carboxylic acids, for example according to DE-A 1 900 270 and US-PS 3 692 744. Examples of preferred branching agents are trimesic acid, trimellitic acid, trimethylolethane and trimethylolpropane, and pentaerythritol. Particular preference is given to aromatic polyalkylene terephthalates which have been prepared solely from terephthalic acid and the reactive derivatives thereof (for example the dialkyl esters thereof) and ethylene glycol and/or butane-1,4-diol, and to mixtures of these polyalkylene terephthalates.

The preferably employed aromatic polyalkylene terephthalates have a viscosity number of 0.4 to 1.5 dl/g, preferably 0.5 to 1.2 dl/g, measured in phenol/o-dichlorobenzene (1:1 parts by weight) at a concentration of 0.05 g/ml according to ISO 307 at 25° C. in an Ubbelohde viscometer. The aromatic polyalkylene terephthalates can be prepared by known methods (see, for example, Kunststoff-Handbuch, volume VIII, p. 695 et seq., Carl-Hanser-Verlag, Munich 1973).

Preferred components B preferably also include polyolefins containing functional groups.

Polyolefins are produced by chain polymerization, for example by free-radical polymerization. Alkenes are used as monomers. An alternative name for alkenes is olefins. The monomers may be polymerized individually or as a mixture of various monomers.

Preferred monomers are ethylene, propylene, 1-butene, isobutene, 1-pentene, 1-heptene, 1-octene and 4-methyl-1-pentene.

The polyolefins are may be semicrystalline or amorphous and linear or branched. The production of polyolefins has long been known to those skilled in the art.

The polymerization may be conducted for example at pressures of from 1 to 3000 bar and temperatures between 20° C. and 300° C., optionally with use of a catalyst system. Examples of suitable catalysts include mixtures of titanium and aluminum compounds, and metallocenes. By modifying the polymerization conditions and the catalyst system, the number of branches, the crystallinity and the density of the polyolefins can be varied within wide ranges. These measures are also familiar to those skilled in the art.

Functional groups are introduced into the polyolefins through copolymerization, preferably by free-radical polymerization, of vinyl monomers containing the functional group with the olefin as described hereinabove. Suitable vinyl monomers are for example glycidyl methacrylate and methyl methacrylate.

An alternative mode of production is free-radical grafting of functional group-containing vinyl monomers onto a polyolefin.

Both production processes may employ not only the vinyl monomers containing functional groups but also further vinyl monomers without functional groups, such as for instance styrene.

The polymers of component B have average molecular weights (weight-average M_{w}, measured by

GPC (gel permeation chromatography) at room temperature against a polystyrene standard) of preferably at least 3000 g/mol, more preferably from 5000 to 200 000 g/mol, particularly preferably from 10 000 to 100 000 g/mol.

The solvent for the GPC measurement is selected such that the component B is readily soluble. A suitable solvent for vinyl copolymers such as polymethyl methacrylate is, for example, tetrahydrofuran.

Component C

A phosphonium salt of formula (4) is employed as Component C

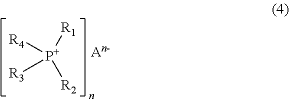

wherein

R₁ and R₂ each independently of one another represent C₁-C₁₀ alkyl, R₃ and R₄ each independently of one another represent C₁-C₁₀-alkyl or C₆-C₁₂-aryl,

A⁻ represents the anion of a carboxylic acid and

n represents 1, 2 or 3.

It is preferable when R₁ and R₂ in formula (4) each independently of one another represent C₁-C₄ alkyl, more preferably at least R₁ or R₂ represent a butyl group, particularly preferably R₁ and R₂ represent butyl groups.

In a further preferred embodiment the alkyl groups are unbranched.

It is most preferable when R₁ and R₂ each represent an n-butyl group.

It is preferable when R₃ and R₄ each independently of one another represent C₁-C₁₀ alkyl.

In a further preferred embodiment at least R₃ or R₄ represents a butyl group, particularly preferably R₃ and R₄ represent butyl groups.

In a further preferred embodiment the alkyl groups are unbranched.

It is most preferable when R₃ and R₄ each represent an n-butyl group.

In the most preferred embodiment R₁, R₂, R₃ and R₄ represent n-butyl groups.

Aⁿ⁻ represents a carboxylate, i.e. the anion of a monocarboxylic acid (n=1), dicarboxylic acid (n=2) or tricarboxylic acid (n=3).

The carboxylic acid may be aliphatic or aromatic. The carboxylic acid is preferably aliphatic.

The carboxylic acid is more preferably selected from formic acid, acetic acid, prionic acid, butyric acid, valeric acid, caproic acid, succinic acid, oxalic acid, malonic acid, fumaric acid, maleic acid and citric acid.

Monocarboxylic acids and dicarboxylic acids are preferred and monocarboxylic acids are particularly preferred.

The carboxylic acid is yet more preferably an aliphatic saturated carboxylic acid.

The carboxylic acid is particularly preferably selected from malonic acid and acetic acid and the anions are thus malonate or acetate. Acetic acid is most preferred.

The lowest yellowing and the lowest haze are achieved with the corresponding acetate ion as part of the catalyst C.

Component C is most preferably tetrabutylphosphonium acetate.

This component is registered as CAS 30345-49-4 and is commercially available.

It can also be advantageous when an acetate anion is used as Aⁿ⁻ and the catalyst C is in the form of an acetic acid complex.

This component is registered as CAS 34430-94-9 and is commercially available.

In this form the catalyst C is a solid at room temperature and may be easily metered into the process according to the invention.

Component D

As component D the process according to the invention may employ one or more polymer additives and further polymeric components distinct from A and B, preferably selected from the group consisting of flame retardants, anti-drip agents, flame retardant synergists, smoke inhibitors, lubricants and demolding agents, nucleating agents, polymeric and nonpolymeric antistats, conductivity additives, stabilizers (for example hydrolysis, heat-aging and UV stabilizers and also transesterification inhibitors), flow promoters, phase compatibilizers, impact modifiers (either with or without a core-shell structure), polymeric blend partners, fillers and reinforcers and dyes and pigments.

When component D is employed it is preferably employed in a proportion of 0.1 to 50% by weight. This proportion is then the sum of all additives and polymeric components employed as component D.

Anti-drip agents, flame retardant synergists, smoke inhibitors, lubricants and demolding agents, nucleating agents, nonpolymeric antistats, conductivity additives and stabilizers are preferably each employed in a proportion of 0.1% to 1% by weight and preferably in total employed in a proportion of 0.1% to 3% by weight based on all components employed in step a) of the process according to the invention.

When flame retardants are used it is preferable to employ 1% to 20% by weight thereof based on all components employed in step a) of the process according to the invention.

When flow promoters, polymeric antistats and phase compatibilizers are employed, the proportion used is in each case preferably 1% to 10% by weight and in total preferably 1% to 15% by weight based on all components employed in step a) of the process according to the invention.

When impact modifiers or polymeric blend partners are employed, the proportion used is in total preferably 1% to 50% by weight based on all components employed in step a) of the process according to the invention.

When dyes or pigments are employed, the proportion used is in total preferably 0.1% to 10% by weight based on all components employed in step a) of the process according to the invention.

When fillers and reinforcers are employed, the proportion used is in total preferably 3% to 30% by weight based on all components employed in step a) of the process according to the invention.

In a preferred embodiment no fillers and reinforcers are employed.

In a preferred embodiment at least one polymer additive selected from the group consisting of lubricants and demolding agents, stabilizers, flow promoters, phase compatibilizers, impact modifiers, further polymeric blend partners, dyes and pigments is employed.

In a preferred embodiment pentaerythritol tetrastearate is used as a demolding agent.

In a preferred embodiment at least one representative selected from the group consisting of sterically hindered phenols, organic phosphites and sulfur-based co-stabilizers is used as a stabilizer.

In a particularly preferred embodiment at least one representative selected from the group consisting of octadecyl-3-(3,5-di-tert-butyl-4-hydroxyphenyl)propionate and tris(2,4-di-tert-butylphenyl)phosphite is used as a stabilizer.

The compositions produced with the process according to the invention may be used to produce molded articles of any kind. These may be produced by injection molding, extrusion and blow-molding processes for example. A further form of processing is the production of molded articles by thermoforming from previously produced sheets or films.

Examples of such molded articles are films, profiles, housing parts of any type, for example for domestic appliances such as juice presses, coffee machines, mixers; for office machinery such as monitors, flatscreens, notebooks, printers, copiers; sheets, pipes, electrical installation ducts, windows, doors and other profiles for the construction sector (internal fitout and external applications), and also electrical and electronic components such as switches, plugs and sockets, and component parts for commercial vehicles, in particular for the automobile sector. The compositions and molding materials according to the invention are also suitable for producing the following molded articles or moldings: internal fitout parts for rail vehicles, ships, aircraft, buses and other motor vehicles, bodywork components for motor vehicles, housings of electrical equipment containing small transformers, housings for equipment for the processing and transmission of information, housings and facings for medical equipment, massage equipment and housings therefor, toy vehicles for children, sheetlike wall elements, housings for safety equipment, thermally insulated transport containers, molded parts for sanitation and bath equipment, protective grilles for ventilation openings and housings for garden equipment.

Further embodiments 1 to 33 of the present invention are described hereinbelow:

1. Process for producing a thermoplastic molding material containing
A) at least one aromatic polycarbonate and
B) a further polymer which is chemically distinct from polymer A and which contains at least one type of functional group selected from ester, epoxy, hydroxyl, carboxyl and carboxylic anhydride groups,
   comprising the steps of
   a) melting and commixing the components A and B in the presence of a catalyst of component C at a temperature in the range from 200° C. to 350° C. and
   b) solidifying the composition by cooling the composition,

wherein the component A has an average molecular weight M_{w} measured by gel permeation chromatography at room temperature in methylene chloride with a bisphenol A-based polycarbonate standard of at least 3000 g/mol, characterized in that

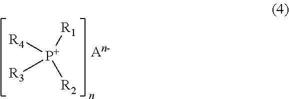

in process step a) at least a portion of the component A is reacted with the component B to afford a copolymer
and wherein the catalyst C is a phosphonium salt according to formula (4)

wherein

R₁ and R₂ each independently of one another represent C₁-C₁₀ alkyl,

R₃ and R₄ each independently of one another represent C₁-C₁₀-alkyl or C₆-C₁₂-aryl,

Aⁿ⁻ represents the anion of a carboxylic acid and

n represents 1, 2 or 3.

2. Process according to embodiment 1, characterized in that the component B is a polymer which is selected from the group consisting of vinyl (co)polymers containing structural units derived from an alkyl ester of acrylic acid, vinyl (co)polymers containing structural units derived from an alkyl ester of an alkyl-substituted derivative of acrylic acid, epoxy-containing vinyl (co)polymers and epoxy-containing polyolefins.

3. Process according to either of the preceding embodiments, characterized in that the mixture of the components A and B has a residual moisture content of 0.01% to 0.50% by weight based on the sum of A and B.

4. Process according to any of the preceding embodiments, characterized in that the mixture of the components A and B has a residual moisture content of 0.07% to 0.20% by weight based on the sum of A and B.

5. Process according to any of the preceding embodiments, characterized in that the copolymer obtained from the reaction of the components A and B is a block copolymer or a graft copolymer which is formed by an epoxy ring-opening addition reaction or a transesterification reaction during the reaction of the components A and B.

6. Process according to any of the preceding embodiments 2 to 5, characterized in that the vinyl (co)polymer used as component B is a (co)polymer of at least one monomer from the group of the (C₁ to C₈)-alkyl (meth)acrylates, unsaturated carboxylic acids and carboxylic anhydrides and further vinyl monomers containing ester, hydroxyl, carboxyl, carboxylic anhydride and epoxy groups.

7. Process according to embodiment 6, characterized in that the vinyl (co)polymer also contains structural units derived from vinylaromatics, vinyl cyanides and olefins.

8. Process according to any of the preceding embodiments 1 to 6, characterized in that the component B is polymethyl methacrylate.

9. Process according to any of the preceding embodiments 1 to 7, characterized in that the component B is a polymer which is selected from the group of epoxy-containing vinyl (co)polymers.

10. Process according to any of the preceding embodiments 1 to 5, characterized in that the component B is a polymer which is selected from the group of epoxy-containing polyolefins.

11. Process according to any of the preceding embodiments, characterized in that the component A is an aromatic polycarbonate based on bisphenol A.

12. Process according to any of the preceding embodiments, characterized in that the component A has a weight-average molecular weight M_{w} measured by gel permeation chromatography at room temperature in methylene chloride with a bisphenol A-based polycarbonate standard of not more than 50 000 g/mol.

13. Process according to any of the preceding embodiments, characterized in that the component A has a weight-average molecular weight M_{w} measured by gel permeation chromatography at room temperature in methylene chloride with a bisphenol A-based polycarbonate standard of 20 000 to 33 000 g/mol.

14. Process according to any of the preceding embodiments, characterized in that in step a)

0.5% to 99% by weight of the component A,

0.5% to 99% by weight of the component B and

0.01% to 0.5% by weight of the component C

are employed.

15. Process according to any of the preceding embodiments, characterized in that in step a)

10% to 89.5% by weight of the component A,

10% to 89.5% by weight of the component B and

0.02% to 0.25% by weight of the component C

are employed.

16. Process according to any of the preceding embodiments, characterized in that in step a)

30% to 84.5% by weight of the component A,

15% to 69.5% by weight of the component B and

0.03% to 0.1% by weight of the component C

are employed.

17. Process according to any of the preceding embodiments, characterized in that polymer additives and/or further polymeric blend partners distinct from the components A and B are further added as component D in step a).

18. Process according to embodiment 17, characterized in that 0.1% to 50% by weight of the component D is employed in step a).

19. Process according to embodiment 17, characterized in that 0.3% to 30% by weight of the component D is employed in step a).

20. Process according to embodiment 17, characterized in that 0.4% to 20% by weight of the component D is employed in step a).

21. Process according to any of the preceding embodiments, characterized in that process step a) is performed in a continuous twin-screw extruder with a residence time in the range from 10 seconds to 2 minutes.

22. Process according to any of the preceding embodiments, characterized in that process step a) is performed in a continuous twin-screw extruder with a residence time in the range from 15 seconds to 1 minutes.

23. Process according to any of the preceding embodiments 1 to 7 and 9 to 22, characterized in that the polymer B is an epoxy-containing vinyl (co)polymer or an epoxy-containing polyolefin and in process step a) at least 5 mol % of the epoxy groups in polymer B are converted.

24. Process according to any of the preceding embodiments 1 to 7 and 9 to 22, characterized in that the polymer B is an epoxy-containing vinyl (co)polymer or an epoxy-containing polyolefin and in process step a) at least 15 mol % of the epoxy groups in polymer B are converted.

25. Process according to any of the preceding embodiments, characterized in that in the catalyst C R₁ and/or R₂ represent an n-butyl group.

26. Process according to any of the preceding embodiments, characterized in that in the catalyst C Aⁿ⁻ represents an acetate ion or malonate ion.

27. Process according to any of the preceding embodiments, characterized in that the catalyst C is tetra-n-butylphosphonium acetate in the form of the acetic acid complex.

28. Process according to any of the preceding embodiments, characterized in that the process is carried out in a temperature range from 220° C. to 300° C.

29. Process according to any of the preceding embodiments, characterized in that the process is carried out in a temperature range from 230° C. to 270° C.

30. Process according to any of the preceding embodiments, characterized in that the catalyst is deactivated or removed in step a) or after step a).

31. Process according to any of the preceding embodiments, characterized in that a degassing of the composition present is carried out after step a) by application of negative pressure.

32. Thermoplastic molding material produced with a process according to any of the preceding embodiments 1 to 31.

33. Molded article containing a thermoplastic molding material according to embodiment 32.

### Examples

Compositions and Components Used Therein

Component A1

Makrolon™ M2408 (Covestro Deutschland AG, Leverkusen) Aromatic polycarbonate based on bisphenol A

Component A2

Makrolon™ M2606 (Covestro Deutschland AG, Leverkusen) Aromatic polycarbonate based on bisphenol A

Component B1

Plexiglas™ 8H (Evonik Performance Materials GmbH, Darmstadt)

Polymethyl methacrylate

Component B2

Fine-Blend™ SAG-008 (Fine-blend Compatibilizer Jiangsu Co., LTD, Shanghai, China) Styrene-acrylonitrile-glycidyl methacrylate random terpolymer. The epoxy content determined according to DIN EN 1877-1 (2000 version) is 2.35% by weight.

Component C1

Tin chloride dihydrate ≥98% (Sigma-Aldrich)

Component C2

Zinc acetate 99.99% (Sigma-Aldrich)

Component C3

Tetrabutylphosphonium acetate-acetic acid complex (Sachem Inc., Austin, USA)

Component C4 Tetrabutylammonium acetate-acetic acid complex Sachem N-416 (Sachem Inc., Austin, USA)

Component C5

Tetrabutylphosphonium malonate ≥92% (Sigma-Aldrich)

Component C6

Tetrabutylphosphonium p-toluenesulfonate ≥95% (Sigma-Aldrich)

Production of the Thermoplastic Molding Materials and Molded Articles

The PC/PMMA molding materials V1, V2, V3, 4, 5, V6, 7 and V8 of table 1 and the PMMA/PC molding materials V11 to V13 and 14 of table 3 were produced on a ZSK26 MC18 twin-screw extruder from Coperion GmbH (Stuttgart, Germany) at a melt temperature at the nozzle outlet of about 260° C. A negative pressure of 100 mbar (absolute) was applied. The residence time of the melt mixture in the extruder was about 30 s.

The molding materials V9 and 10 composed of polycarbonate and styrene-acrylonitrile-glycidyl methacrylate terpolymer according to Table 2 were produced on a Process 11 twin-screw extruder from Thermo Fisher Scientific Inc. (Karlsruhe, Germany) at a melt temperature at the nozzle outlet of about 260° C. No negative pressure was applied. The residence time of the melt mixture in the extruder was about 60 s.

The molded articles for the tests were produced at a melt temperature of 260° C. and at a mold temperature of 80° C. in an Arburg 270 E injection molding machine.

Determination of Residual Moisture Content of A and B

The residual moisture content (in this application also referred to synonymously as water content) of A and B based on A+B was determined by Karl Fischer titration according to DIN 51777 (2014 version) of the optionally pre-dried components A and B and calculated from the thus-determined residual moisture values of components A and B according to:

water content of A and B (based on A+B)=(residual moisture content of A×mass fraction of A+residual moisture content of B×mass fraction of B)/(mass fraction of A+mass fraction of B)

Determining Conversion of Epoxy Functionalities

The conversion of the epoxy functionalities in the polymer B2 during the reactive compounding with component A2 was determined according to DIN EN 1877-1 (2000 version) by titrimetric determination of the epoxy content in the component B2 and in the thermoplastic molding materials produced therefrom by reactive compounding with component A2 in the presence or absence of a catalyst according to the invention. For the titration, the samples were dissolved at room temperature in a mixture of dichloromethane and acetic acid in a mixing ratio of 40 ml to 25 ml.

Testing of the Molding Materials

The elastic modulus was determined at room temperature according to ISO 527 (1996 version).

The yellowness index and haze value were determined on color sample plates having dimensions of 60 mm×40 mm×2 mm according to DIN 6174 (2007 version) and ASTM D 1003 (2013 version).

Detection of Copolymer Formation During Reactive Compounding of PC with PMMA

5 g of the pellet material of the respective thermoplastic PC/PMMA molding material to be examined which was produced in the described compounding process were extracted in 100 ml of acetone in a round-bottomed flask for 24 h at room temperature (about 25° C.) with stirring. The acetone-insoluble proportion of the PC/PMMA molding material was then separated from the acetone comprising the extracted, i.e. acetone-soluble, proportion of the PC/PMMA molding material by filtration. The filtration residue (acetone-insoluble proportion of the molding material) was washed once with acetone in the filtration funnel. The insoluble proportion of the PC/PMMA molding material was then dried in a convection oven at 60° C. To recover the acetone-soluble proportion of the PC/PMMA molding material the acetone was distillatively removed from the filtrate using a rotary evaporator.

The thus-obtained acetone-soluble and -insoluble proportions of the PC/PMMA molding materials were then analyzed by FTIR infrared spectroscopy using a Nicolet Nexus 470 FT-IR spectrometer with ATR (attenuated total reflection) measurement technology from ThermoFisher Scientific (Karlsruhe, Germany) in the measurement range from 600 to 4000 cm−1 at a resolution of 1 cm⁻¹. The CO double bond vibration is used for analytical detection and differentiation of polycarbonate and PMMA. This selective vibration is observed for polycarbonate in a wavenumber range of around 1775 cm⁻¹ and for PMMA in a wavenumber range of around 1725 cm′.

Examination of Polymer Compatibility by Transmission Electron Microscopy

The polymer compatibility of the components A and B in the molding materials composed of polycarbonate and styrene-acrylonitrile-glycidyl methacrylate was examined using transmission electron microscopy (TEM). To this end, an EM UC7 ultramicrotome from Leica Microsystems GmbH (Wetzlar, Germany) was used to produce ultrathin sections of a pellet of the molding materials produced in the described compounding process. The ultrathin sections were made with a diamond knife and collected in a dimethyl sulfoxide/water mixture at −30° C. For TEM examination the ultrathin sections were placed on a carbon-coated copper grid and contrasted with ruthenium tetraoxide (Ruth). The Ruth contrasting was effected via an in-situ reaction in which 1 ml of sodium hypochlorite solution was added to 13 mg of ruthenium(III) chloride (RuCl₃). This forms Ruth vapor in which the grids with the ultrathin sections were stored for 15 min. The TEM recordings were made in the bright field at an accelerating voltage of 200 kV with a LEO 922A EFTEM transmission electron microscope from Carl Zeiss Microscopy GmbH (Jena, Germany).

### DESCRIPTION OF THE FIGURES

FIG. 1

FTIR spectrum (E represents extinction and v represents wavenumber)

1: Component A1

2: Component B1

3: acetone-insoluble proportion of molding material V1

4: acetone-soluble proportion of molding material V1

5: acetone-insoluble proportion of molding material 4

6: acetone-soluble proportion of molding material 4

FIG. 2

FTIR spectrum (E represents extinction and v represents wavenumber)

1: acetone-insoluble proportion of molding material 5

2: acetone-insoluble proportion of molding material 4

FIG. 3

TEM image of a microtome section of a pellet of molding material V9

FIG. 4

TEM image of a microtome section of a pellet of molding material 10

TABLE 1
PC/PMMA molding materials and their properties

| | Example | | | | | | | |
|---|---|---|---|---|---|---|---|---|
| | V1 | V2 | V3 | 4 | 5 | V6 | 7 | V8 |
| | Composition | | | | | | | |
| | parts | parts | parts | parts | parts | parts | parts | parts |
| | by wt. | by wt. | by wt. | by wt. | by wt. | by wt. | by wt. | by wt. |
| A1 | 50 | 50 | 50 | 50 | 50 | 50 | 50 | 50 |
| B1 | 50 | 50 | 50 | 50 | 50 | 50 | 50 | 50 |
| C1 | | 0.05 | | | | | | |
| C2 | | | 0.05 | | | | | |
| C3 | | | | 0.05 | 0.05 | | | |
| C4 | | | | | | 0.05 | | |
| C5 | | | | | | | 0.05 | |
| C6 | | | | | | | | 0.05 |
| Water content A + B | 0.105 | 0.105 | 0.105 | 0.105 | 0.060 | 0.105 | 0.105 | 0.105 |
| [% by wt. based on | | | | | | | | |
| A + B] | | | | | | | | |
| Properties | | | | | | | | |
| Elastic modulus [MPa] | 2748 | 2875 | 2799 | 2838 | 2809 | 2741 | 2831 | 2779 |
| Yellowness index | 39.7 | 8.2 | 48.4 | 1.8 | 4.7 | 46.0 | 2.1 | 38.9 |
| Haze | 99.4 | 11.4 | 98.7 | 0.5 | 7.9 | 98.4 | 2.3 | 99.3 |

The data in table 1 show that the catalysts C3 and C5 according to the invention achieve lower yellowness indexes and higher transparencies (lower haze) than the catalysts C1 and C2 described in the prior art or the catalysts C4 and C6 which are structurally analogous to the catalysts according to the invention but are not catalysts according to the invention. Transparency is not achieved without a catalyst (comparative example V1). Higher elastic moduli are also achieved with the catalysts according to the invention than without a catalyst and a higher surface hardness and thus scratch resistance can therefore also be assumed.

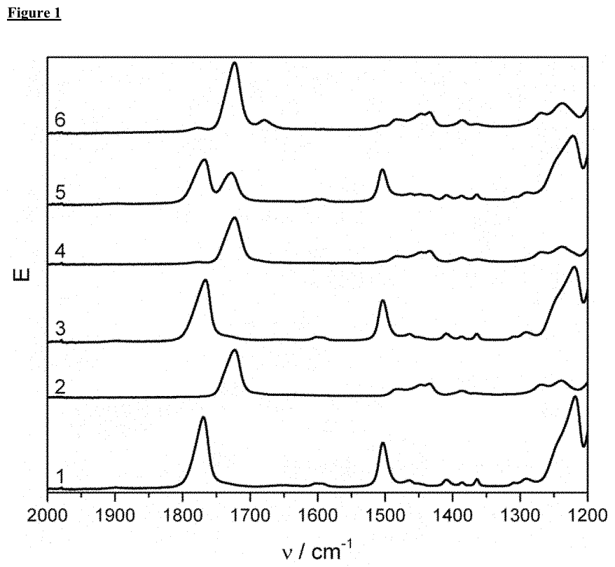

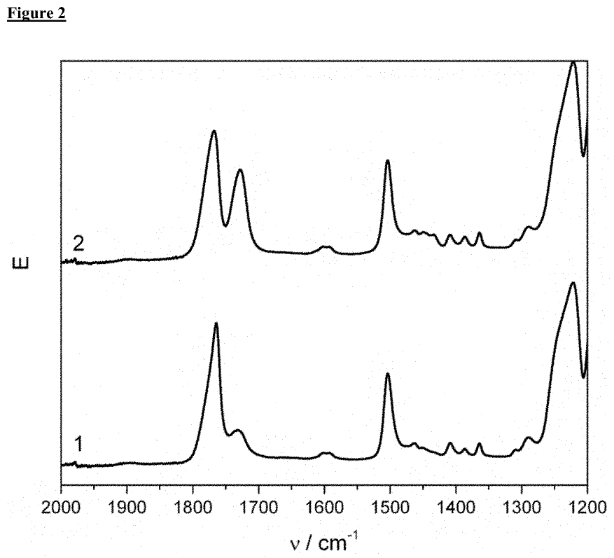

The FTIR examinations in FIGS. 1 and 2 demonstrate that the reactive compounding of the molding materials 4 and 5 according to the invention results in formation of PC-PMMA copolymers by reaction of the component A1 with the component B1, wherein FIG. 2 further demonstrates that in the molding material 4, which was produced with the preferred higher water content in the mixture of components A1 and B1, a greater amount of these PC-PMMA copolymers was formed.

A comparison of the properties of the molding materials 4 and 5 of table 1 according to the invention shows that when using the catalysts according to the invention it is advantageous in terms of optimizing transparency, yellowness index and elastic modulus when the polymeric components A and B contain a minimum amount of moisture.

TABLE 2
PC/styrene-acrylonitrile-glycidyl
methacrylate compositions

| Example | V9 | 10 |
|---|---|---|
| Composition | parts by wt. | parts by wt. |
| A2 | 80 | 80 |
| B2 | 20 | 20 |
| C3 | | 0.05 |
| Water content A + B | 0.044 | 0.044 |
| [% by wt. based on A + B] | | |
| Properties | | |
| Epoxy content [% by wt.] | 0.46 | 0.39 |
| Epoxy conversion | 2 | 17 |
| (calculated) [%] | | |

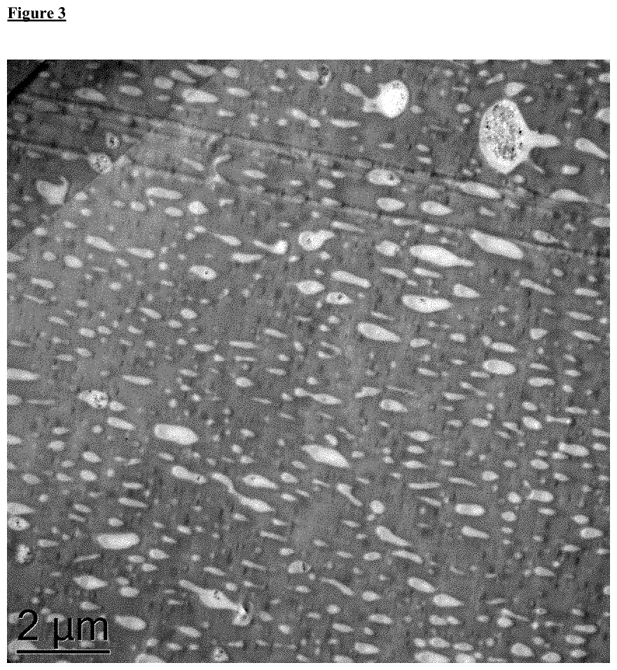

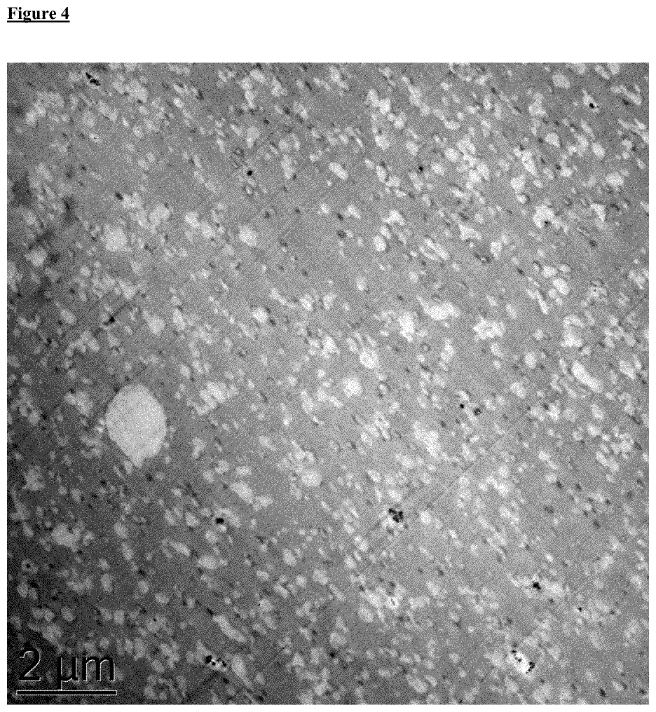

The data in table 2 show that in the presence of the catalyst according to the invention the process according to the invention can achieve a conversion of the epoxide of 15% in a twin-screw extruder with a residence time of about 60 seconds while in a process according to the prior art without such a catalyst such a conversion does not take place. A comparison of FIGS. 3 and 4 further shows that this conversion of the epoxide makes it possible to achieve a markedly finer phase dispersion of the styrene-acrylonitrile-glycidyl methacrylate terpolymer of component B in polycarbonate of component A.

TABLE 3
PMMA/PC molding materials and their properties

| Example | V11 | V12 | V13 | 14 |
|---|---|---|---|---|
| Composition | parts | parts | parts | parts |
| | by wt. | by wt. | by wt. | by wt. |
| A1 | 20 | 20 | 20 | 20 |
| B1 | 80 | 80 | 80 | 80 |
| C1 | | 0.3 | | |
| C2 | | | 0.3 | |
| C3 | | | | 0.3 |
| Water content | 0.090 | 0.090 | 0.090 | 0.090 |
| A + B | | | | |
| [% by wt. based | | | | |
| on A + B] | | | | |
| Properties | | | | |
| Elastic modulus | 3087 | 3124 | 3084 | 3210 |
| [MPa] | | | | |
| Yellowness index | 48.01 | 15.4 | 16.9 | 4.5 |
| Haze | 98.26 | 44.2 | 11.8 | 0.5 |

The examples in table 3 show that the PMMA/PC molding material 14 according to the invention which was produced with an catalyst according to the invention exhibits better transparency (lower haze), a lower intrinsic color (lower yellowness index) and a higher elastic modulus.

1. A process for producing a thermoplastic molding material containing
A) at least one aromatic polycarbonate and
B) a further polymer which is chemically distinct from polymer A and which contains at least one type of functional group selected from ester, epoxy, hydroxyl, carboxyl and carboxylic anhydride groups,
the process comprising the steps of
a) melting and commixing components A and B in the presence of a catalyst of component C at a temperature in the range from 200° C. to 350° C. and
b) solidifying the composition by cooling the composition,
wherein component A has an average molecular weight M_{w} measured by gel permeation chromatography at room temperature in methylene chloride with a bisphenol A-based polycarbonate standard of at least 3000 g/mol,
wherein
in process step a) at least a portion of component A is reacted with component B to produce a copolymer
and wherein catalyst C is a phosphonium salt according to formula (4) 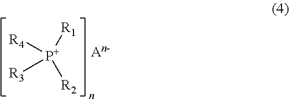
wherein
R₁ and R₂ each independently of one another represent C₁-C₁₀ alkyl,
R₃ and R₄ each independently of one another represent C₁-C₁₀-alkyl or C₆-C₁₂-aryl,
Aⁿ⁻ represents an anion of a carboxylic acid and
n represents 1, 2 or 3.

2. The process as claimed in claim 1, wherein component B is a polymer selected from the group consisting of vinyl (co)polymers containing structural units derived from an alkyl ester of acrylic acid, vinyl (co)polymers containing structural units derived from an alkyl ester of an alkyl-substituted derivative of acrylic acid, epoxy-containing vinyl (co)polymers, and epoxy-containing polyolefins.

3. The process as claimed in claim 1, wherein the mixture of the components A and B has a residual moisture content of 0.01% to 0.50% by weight based on the sum of A and B.

4. The process as claimed in claim 1, wherein that the component B is polymethyl methacrylate.

5. The process as claimed in claim 1, wherein component B is a polymer selected from the group consisting of epoxy-containing vinyl (co)polymers and epoxy-containing polyolefins.

6. The process as claimed in claim 1, wherein component A is an aromatic polycarbonate based on bisphenol A.

7. The process as claimed in claim 1, wherein polymer additives and/or further polymeric blend partners distinct from the components A and B are added as component D in step a).

8. The process as claimed in claim 7, wherein in step a) the composition comprises
0.5% to 99% by weight of the component A,
0.5% to 99% by weight of the components B,
0.01% to 0.5% by weight of the component C and
0.1% to 50% by weight of the component D.

9. The process as claimed in claim 1, wherein process step a) occurs in a continuous twin-screw extruder with a residence time of from 15 seconds to 1 minute.

10. The process as claimed in claim 1, wherein component B is an epoxy-containing vinyl (co)polymer or an epoxy-containing polyolefin and in process step a) at least 5 mol % of the epoxy groups in component B are converted.

11. The process as claimed in claim 1, wherein in catalyst C at least one of R₁ and/or R₂ represent an n-butyl group.

12. The process as claimed in claim 1, wherein in the catalyst C Aⁿ⁻ represents an acetate ion or malonate ion.

13. The process as claimed in claim 1, wherein catalyst C is tetra-n-butylphosphonium acetate in the form of the acetic acid complex.

14. A thermoplastic molding material produced with a process according to claim 1.

15. A molded article containing a thermoplastic molding material as claimed in claim 14.
